(19) United States
(12) Patent Application Publication
(10) Pub. No.: US 2016/0292861 A1
(43) Pub. Date: Oct. 6, 2016

(54) CALIBRATION PATTERN FOR A CAMERA

(71) Applicant: VIT, Saint-Egreve (FR)

(72) Inventors: Christian WOLF, Saint Egreve (FR); François DUPLAIX, Saint Egreve (FR)

(21) Appl. No.: 14/778,276

(22) PCT Filed: Mar. 26, 2014
(86) PCT No.: PCT/FR2014/050708

§ 371 Date: Sep. 18, 2015

(30) Foreign Application Priority Data
Mar. 29, 2013 (FR) 1352929

(51) Int. Cl. G06T 7/00; H04N 17/00; G01N 21/93

(52) U.S. Cl. CPC G06T 7/0018; G01N 21/93; H04N 17/002; G06T 7/0004; G06T 2207/30141

(57) ABSTRACT

A calibration pattern for an optical system is formed by an anodized metal plate comprising grooves.

### BACKGROUND

The present disclosure generally relates to image capture systems and, more specifically, to systems of optical inspection, for example, of electronic boards. The present disclosure relates to a calibration target or target of the cameras of such an installation.

### DISCUSSION OF THE RELATED ART

Optical inspection and more generally image capture installations need to be calibrated. For this purpose, calibration targets which are generally formed of a two-colored checkerboard alternating white boxes and boxes of a given color are used.

The more accurate the resolution of the image capture system should be, the more accurate the calibration target should itself be. This considerably increases the cost of targets and reserves their use to maintenance operations.

Document US-A-2012/0327214 describes an image calibration system and method where a two-colored checkerboard is obtained by forming contrasting marks by laser etching in a dark-colored anodized plate.

Document US-A-2006/0285112 describes a method and a system for determining a drift in the position of a light beam, where trenches are formed in a black anodized aluminum plate to form white lines.

These two solutions result in two-colored checkerboards or linear structures (white and black).

### SUMMARY

It would be desirable to have a calibration target which can be integrated in the image capture installation. For this purpose, it would be desirable to have a calibration target of low cost as compared with maintenance targets.

An embodiment aims at providing a calibration target adapted to optical inspection installations.

An embodiment aims at a calibration target capable of permanently fitting the installation for a periodic use.

An embodiment aims at a calibration target adapted to a calibration process during which patterns are projected on the target.

Thus, an embodiment provides an optical system calibration target, formed of an anodized metal plate comprising grooves.

According to an embodiment, the depth of the grooves does not exceed the thickness of the anodization.

According to an embodiment, the grooves form a grid.

According to an embodiment, the grid defines boxes, all having the same color, and grooves contrasting each other.

According to an embodiment, the grooves are brighter than the boxes.

According to an embodiment, the anodization is a color anodization.

According to an embodiment, the color of the anodization is selected from among light colors.

According to an embodiment, the color of the anodization is selected from among RAL colors 1004, 6034, 9006, and 3015.

According to an embodiment, the width of the grooves is in range from some hundred to a few hundreds of micrometers.

According to an embodiment, the target is made of anodized aluminum.

According to an embodiment, the grooves result from a laser etching.

According to an embodiment, the target is applied to a calibration of an installation of optical electronic board inspection.

### BRIEF DESCRIPTION OF THE DRAWINGS

The foregoing and other features and advantages will be discussed in detail in the following non-limiting description of specific embodiments in connection with the accompanying drawings, among which:

FIG. 1 is a simplified perspective representation of an optical inspection installation of the type to which the calibration target which will be described more particularly applies;

FIG. 2 is a partial top view of an embodiment of a calibration target; and

FIG. 3 is a cross-section view of the target of FIG. 2.

### DETAILED DESCRIPTION

The same elements have been designated with the same reference numerals in the different drawings. For clarity, only those steps and elements which are useful to the understanding of the embodiments which will be described have been shown and will be detailed. In particular, the optical inspection processes have not been detailed, the calibration target being compatible with any optical inspection installation and, more generally, with any image capture system. Further, the use of the target for calibration purposes has not been detailed either, the interpretation of the images taken with the target being here again compatible with methods of processing the images taken with usual targets.

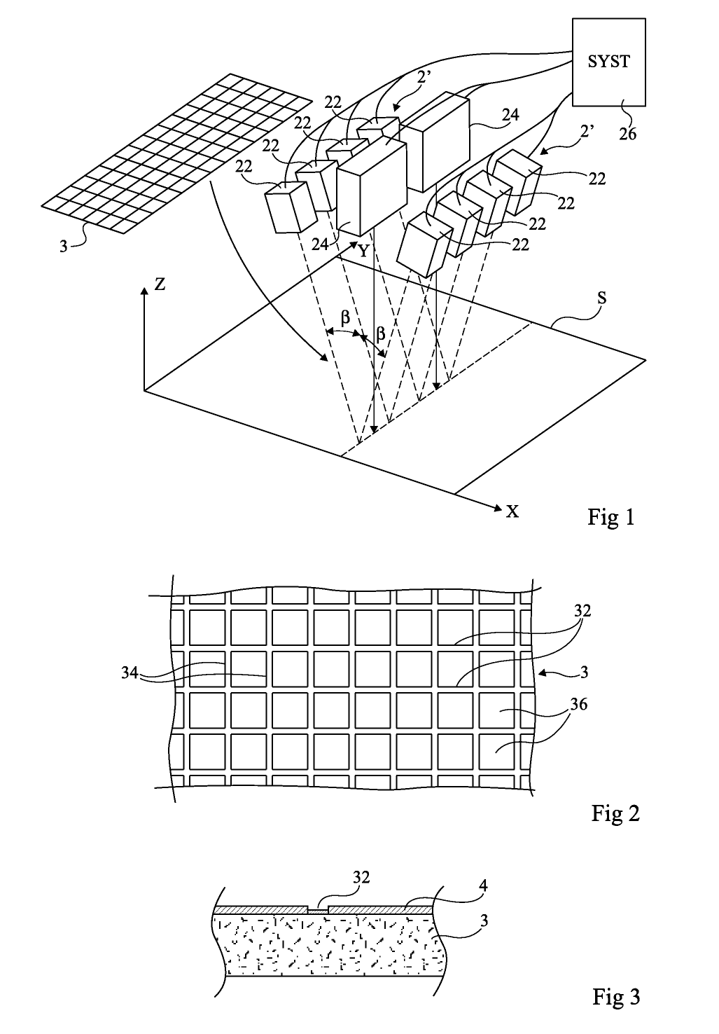

FIG. 1 is a simplified perspective representation of an arbitrary example of an installation of optical inspection, for example, of electronic circuit boards. In this example, the installation comprises two projectors 24 of images in a scene S and two groups 2′ of four cameras 22 aligned along two parallel lines in a direction Y, perpendicular to a direction X of conveyance of the boards to be inspected by image capture. Still arbitrarily, in the shown example, the two groups 2′ are placed on either side of projectors 24, also aligned along a line parallel to direction Y. Cameras 22 are positioned so that their respective viewing points are aligned along direction Y and are paired, a camera of each group aiming at the same point as the camera of the other group which is symmetrical thereto with respect to axis Y. This amounts to inclining all the cameras by an angle β relative to vertical direction Z. The cameras and projectors are connected to a system 26 (SYST) for controlling and processing the taken digital images, typically a computing tool.

The example of the installation of FIG. 1 corresponds to an example described in European patent application N°2413132 of the applicant.

To calibrate the optical inspection system, a target 3 placed in scene S instead of an electronic board is used during calibration phases.

Usually, such targets are formed of checkerboards alternating white boxes and black or color boxes. Such targets operate properly. However, due to the desired accuracy, their manufacturing cost is high, which limits their use to maintenance operations and does not enable, in practice, to fit each installation with a target.

It could have been devised to form targets by inkjet printing on rigid pates or on sheets glued to such plates. However, such a technique would not provide the durability necessary for the product, the printing being likely to alter with temperature and over time. Further, the inaccuracy of a gluing and possible subsequent separations make such a solution non-adapted.

It could be devised to perform a laser printing of a checkerboard alternating white boxes and black or color boxes. However, a printing by laser techniques generally provides a shiny surface result. Such a surface state raises an issue in installations more specifically targeted by the present disclosure. In particular, when the calibration requires a step of projecting an image or patterns in the scene, a shiny target causes disturbances due to reflections.

Thus, another constraint is to have a matt surface compatible with a calibration, with and without image projection.

The inventors have observed that a specific nature of material could satisfy these aims. It is thus provided to use an anodized metal plate and to etch this plate, preferably by laser.

Preferably, the anodization is a color anodization by means of pigments present in the anodizing bath. The color is selected according to its intensity, sufficiently light to allow image projection, but not too much so that it can be made out from the lines. Preferably, a champagne/gold type color, having RAL code 1004, will be selected. Other shades such as, for example, turquoise—RAL code 6034, aluminum—RAL code 9006, or pink—RAL code 3015 or the like are also particularly appropriate tradeoffs.

The etching is performed without exceeding the thickness of the anodized layer, that is, without reaching the non-treated metal. In practice, such an etching vaporizes the pigments and provides the contrast required for the optical inspection by creating lines of lighter color.

Actually, the etching causes a contrast between etched areas and non-etched areas. Preferably, this contrast is of at least 25%.

According to an embodiment, a checkerboard pattern such as in usual targets is formed.

According to another preferred embodiment, applied to the case where the etching is performed by laser, the two-colored checkerboard is replaced with a grid-type pattern.

According to this preferred embodiment, a grid where all boxes have the same color and are separated from one another by the brighter grooves is obtained.

The inventors have indeed observed that such a target is compatible with a calibration, provided for the width of the lines and particularly for their intersections to be sufficiently clear.

Economically advantageous laser etching processes suffer from stops and starts of the etched areas which do not respect the required accuracy. This would lead to believe that the use of an etching laser is incompatible with the forming of a calibration target due to the inaccuracy at the laser stopping and starting. However, the fact of forming continuous lines all along the plate results in the occurrence of such inaccuracies, on etching, at the ends of the plate, or even outside thereof. Accordingly, the obtained lines are particularly accurate, which would not be the case when forming a checkerboard by laser etching.

FIG. 2 is a top view of an example of a calibration target 3, obtained by laser etching. In this example, grooves 32 and 34 in two perpendicular directions are formed and squares 36 of the color of the anodization, surrounded by lighter grooves 32 and 34, are obtained.

FIG. 3 is a cross-section view of target 3 of FIG. 2. The anodization layer is symbolized by a thickness 4 at the upper surface of metal layer 3. The etching results in the creation of grooves 32 (or 34) defining lines where the thickness of layer 4 is smaller.

Typically, it is known to form anodization layers of a few microns (for example, from 20 to 100 micrometers) and a laser etching may etch this layer across a thickness in the range from a few micrometers to a few tens of micrometers (for example, between 2 and 30 micrometers).

As an alternative embodiment, it should be noted that lines 32 and 34 non-perpendicular to one another may be formed, all lines 32, respectively 34, being preferably parallel to one another.

According to another variation, by using etching means which do not have the inaccuracy of a laser during changes of direction (stops/starts), broken lines having any pattern may be formed. The etched pattern is however selected to be compatible with the projected images which, as an example, form a checkerboard (illuminated areas and non-illuminated areas).

The material forming target 3 is metallic to be compatible with an anodization. As a preferred embodiment, an aluminum plate which is advantageous in terms of cost will be used.

The dimensions of calibration target 3 are selected according to the field of vision of the installation for which it is intended, to occupy the entire field.

As a specific embodiment, the width of lines 32 and 34 is in the range from some hundred micrometers to a few hundred micrometers and the lines are separated from one another in a same direction by a few millimeters, for example, in the order of 5 mm.

An advantage of the above-described embodiments is that it is now possible to fit an optical installation with a calibration target which permanently remains therein and which is displaced, for example, by an automated system, in the field of vision of the scene when a calibration is necessary. This enables to perform more frequent periodic calibrations and thus improves the quality of the performed optical inspections.

Various embodiments have been described, various alterations and modifications will occur to those skilled in the art. In particular, the practical carrying out of the anodization and of the laser etching of the target is within the abilities of those skilled in the art based on the functional indications given hereabove and by using usual techniques. Further, the selection of the pattern in the calibration target is also within the abilities of those skilled in the art according to its optical installation and to the projected patterns. Further, although the described target is more particularly intended to be permanently present in optical inspection equipment, it is compatible with a use during maintenance operations.

1. An optical system calibration target, formed of an anodized metal plate comprising grooves having a depth which does not exceed the thickness of the anodization.

2. The target of claim 1, wherein the grooves form a grid.

3. The target of claim 2, wherein the grid defines boxes, all having the same color, and grooves, the grooves and the boxes contrasting each other.

4. The target of claim 2, wherein the grid defines boxes, all of the same color, separated by the brighter grooves.

5. The target of claim 1, wherein the anodization is a color anodization.

6. The target of claim 1, wherein the color of the anodization is selected from among light shades.

7. The target of claim 1, wherein the color of the anodization is selected from among RAL colors 1004, 6034, 9006, and 3015.

8. The target of claim 1, wherein the groove width is in the range from some hundred to a few hundreds of micrometers.

9. The target of claim 1, made of anodized aluminum.

10. The target of claim 1, wherein the grooves result from a laser etching.

11. The target of claim 1, applied to a calibration of an installation of optical inspection of electronic boards.
